(19) United States
(12) Patent Application Publication
(10) Pub. No.: US 2007/0046059 A1
(43) Pub. Date: Mar. 1, 2007

(54) Vehicle undersiding

(76) Inventors: Chris Shepherd, Issaquah, WA (US); John Cahill, Hudson, OH (US); Earl Shepherd, Sammamish, WA (US)

Correspondence Address: FLYNN THIEL BOUTELL & TANIS, P.C., 2026 RAMBLING ROAD, KALAMAZOO, MI, 49008-1631, US

(21) Appl. No.: 11/217,723

(22) Filed: Sep. 1, 2005

(51) Int. Cl. B60R 13/00

(52) U.S. Cl. 296/39.1

(57) ABSTRACT

A vehicle undersiding is attached to the frame of a vehicle to protect the underneath of the vehicle from external moisture and vapor. The vehicle undersiding is made up of a laminate having a first component comprising a first moisture and vapor barrier attached to a second component comprising a second moisture and vapor barrier. The undersiding provides extended protection to the underneath of the vehicle from damage by road debris and external moisture and vapor.

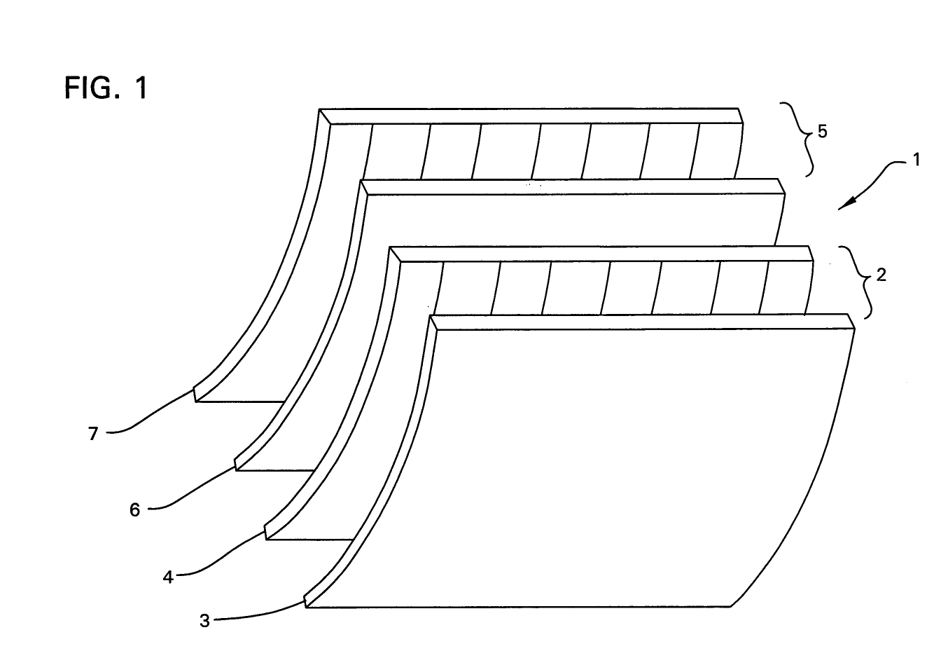

### FIELD OF THE INVENTION

The present invention relates to a vehicle having an undersiding that is attached to a frame thereof to protect the underneath of the vehicle from external moisture and vapor and which comprises a laminate formed from at least two components, the first component comprising a first moisture and vapor barrier attached to a second component comprising a second moisture and vapor barrier.

### BACKGROUND OF THE INVENTION

Vehicles, including mobile homes, cars, trucks, vans, trailers, recreational vehicles and other conveyances, have become indispensable parts of every day life. In order to obtain an extended service life of the vehicles, different measures have been taken in order to protect the vehicle from external environmental hazards. To protect the underneath of the vehicle from road debris and corrosion due to moisture and vapor damage, undersidings have been provided underneath the vehicle.

U.S. Pat. No. 3,188,694 discloses a mobile home frame in which, to provide a weather-resistant bottom for the structure, sheathing extending the length of the coach is suitably attached atop the base frame. The sheathing is disclosed as being a weatherproof composition fiberboard which will withstand exposure to the weather and protect the flooring and other elements disposed above it.

It is also known to provide an undercoating comprising a single coating to protect the vehicle floor system from moisture damage. However, these coatings are easily damaged by sand, gravel and other roadway debris and once the coating is damaged, the chances of moisture and vapor problems arising in the floor system are significantly increased.

### SUMMARY OF THE INVENTION

It is an object of the present invention to provide a vehicle having a vehicle undersiding which provides enhanced protection to the underneath of the vehicle from external moisture and vapor.

It is a further object of the present invention to provide a vehicle having a vehicle undersiding having enhanced protection against external factors such as roadspray, abrasive debris, road solvents, vapor intrusion and U.V. degradation and which can be easily installed and has enhanced durability.

These and other objects of the present invention are achieved by providing a vehicle comprising a frame and an undersiding attached to the frame for protecting the underneath of the vehicle from external moisture and vapor in which the improvement comprises the undersiding comprising a laminate having a first component comprising a first moisture and vapor barrier attached to a second component comprising a second moisture and vapor barrier.

### BRIEF DESCRIPTION OF THE DRAWING

The FIGURE illustrates a vehicle undersiding according to an embodiment of the present invention.

### DETAILED DESCRIPTION

As illustrated in the FIGURE, the vehicle undersiding 1 used in the present invention comprises a laminate 1 formed from a first component 2 laminated to a second component 5. In the embodiment illustrated in the FIGURE, the first component 2 comprises a film 4 having a first coating 3 applied thereon. The first film 4 can be a thermoplastic material, such as a polyolefin, a polyester, a polyamide, and blends and copolymers thereof. The polyolefin can be at least one member selected from the group consisting of polyethylene, polypropylene, blends and copolymers thereof. Additionally, the thermoplastic first film 4 can be either a woven or non-woven fabric.

As illustrated in the FIGURE, a first coating 3 can be applied onto the first film 4. The first coating 3 is preferably a thermoplastic material, with a polyolefin such as polypropylene, polyethylene, polyolefin blends or polyolefin copolymers being preferred. The first coating 3 can be applied to the first film 4 by either extrusion lamination, thermal bonding, ultrasonic bonding or by a suitable adhesive. The thickness of the first component can be anywhere from 1 mil to 6 mils, with a 1 mil thickness being preferred.

The second component 5 can be made in a manner similar to the first component 2. That is, the second component 5, as illustrated in the FIGURE, comprises a second film 7 having a second coating 6 applied thereto. As with the first film 4, the second film 7 can also be a thermoplastic material as described for the first film 4. Likewise, the second coating 6 can be a thermoplastic material such as described for the first coating 3 and is applied to the second film 7 in a similar manner as the first coating 3 is applied to the first film 4. Although the first component 2 and the second component 5 can be identical, they also can be dissimilar with a preferred construction being the first film 4 and the second film 7 being formed from a woven polypropylene fabric and the first coating 3 and the second coating 6 being polypropylene.

The first component 2 and a second component 5 can be laminated together to form the undersiding laminate 1 of the present invention by any suitable method such as co-extrusion lamination, thermal bonding, ultrasonic bonding or through the use of a suitable adhesive.

Although the Figure shows the first and second components as comprising a film having a coating provided thereon, the present invention is not limited to this embodiment and each of the first and second components can be formed of a thermoplastic film which are then laminated to each other by extrusion lamination, thermal bonding, ultrasonic bonding or through an adhesive to form the vehicle undersiding laminate 1. The thermoplastic materials are preferably a polyester, a polyamide, a polyolefin, such as polypropylene, polyethylene, and blends and copolymers thereof. The first and second components can be formed solely from uncoated thermoplastic films which are laminated to each other as long as the moisture and vapor barrier properties associated with the first and second components are independent of each other.

Although the undersiding laminate 1 of the present invention has been described as being formed from two components, the present invention is not limited thereto and can comprise as many other components or plies as needed for the intended service, with the proviso that at least two plies or components be present in the laminate 1.

Although a particularly preferred embodiment of the present invention has been disclosed in detail for illustrative purposes, it will be recognized in variations or modifications of the disclosed invention, including the use of equivalent components, lying within the scope of the present invention.

What is claimed is:

1. In a vehicle comprising a frame and an undersiding attached to the frame for protecting the underneath of the vehicle from external moisture and vapor, the improvement comprising said undersiding comprising a laminate having a first component comprising a first moisture and vapor barrier attached to a second component comprising a second moisture and vapor barrier.

2. The vehicle of claim 1, wherein said first moisture and vapor barrier comprises a thermoplastic material and said second moisture and vapor barrier comprises a thermoplastic material.

3. The vehicle of claim 2, wherein the thermoplastic material is at least one member selected from the group consisting of a polyester, a polyamide, a polyolefin, and blends and copolymers thereof.

4. The vehicle of claim 2, wherein at least one of said first and second moisture and vapor barriers comprises a polyolefin.

5. The vehicle of claim 4, wherein the polyolefin is at least one member selected from the group consisting of polyethylene, polypropylene, blends thereof and copolymers thereof.

6. The vehicle of claim 4, wherein the polyolefin is in the form of a woven fabric.

7. The vehicle of claim 2, wherein a thermoplastic coating is provided on a thermoplastic material of the first and second moisture and vapor barriers.

8. The vehicle of claim 7, wherein the thermoplastic coating comprises at least one member selected from the group consisting of polyethylene, polypropylene, blends thereof and copolymers thereof.

9. The vehicle of claim 4, wherein the polyolefin is in the form of a non-woven fabric.

10. The vehicle of claim 4, wherein the polyolefin is in the form of an extruded film.

11. The vehicle of claim 1, wherein the vehicle is a recreational vehicle.
